(19) United States
(12) Patent Application Publication
(10) Pub. No.: US 2009/0089161 A1
(43) Pub. Date: Apr. 2, 2009

(54) INTEGRATING ENCAPSULATED ADVERTISEMENT CONTROLS

(75) Inventors: MAHBUBUL ALAM ALI, REDMOND, WA (US); PRASANTH PULAVARTHI, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/864,340

(22) Filed: Sep. 28, 2007

(51) Int. Cl. G06Q 30/00

(52) U.S. Cl. 705/14

(57) ABSTRACT

Computer-readable media, systems, and methods for integrating advertisements using encapsulated advertisement controls are described. In embodiments, one or more embedding instructions are received for embedding one or more encapsulated advertisement controls within an application, the one or more encapsulated advertisement controls including logic for handling of one or more advertisements and presentation of the advertisements to a user of the application. Further, in embodiments, one or more configuration instructions are received for configuring the one or more encapsulated advertisement controls. Still further, in embodiments, one or more advertisements are presented to a user of the application in accordance with the one or more advertisement presentation parameters.

### CROSS-REFERENCE TO RELATED APPLICATIONS

Not applicable.

### SUMMARY

Embodiments of the present invention provide computer-readable media, systems, and methods for integrating encapsulated advertisement controls. In embodiments, one or more embedding instructions are received for embedding one or more encapsulated advertisement controls within an application. The one or more encapsulated advertisement controls include logic for handling of one or more advertisements and presentation of the advertisements to a user of the application. Also, one or more configuration instructions are received for configuring the one or more encapsulated advertisement controls. Further, in embodiments, one or more advertisements are presented to the user in accordance with one or more presentation parameters.

It should be noted that this Summary is provided to generally introduce the reader to one or more select concepts described below in the Detailed Description in a simplified form. The Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram of an exemplary computing system environment suitable for use in implementing the present invention;

FIG. 2 is a block diagram illustrating an exemplary system for integrating encapsulated advertisement controls, in accordance with an embodiment of the present invention;

FIG. 3 is a flow diagram illustrating an exemplary method for integrating encapsulated advertisement controls, in accordance with an embodiment of the present invention; and

FIG. 4 is a flow diagram illustrating an exemplary method for integrating encapsulated advertisement controls, in accordance with an embodiment of the present invention, the flow having a different perspective than the flow illustrated in FIG. 3.

### DETAILED DESCRIPTION

The subject matter of the present invention is described with specificity herein to meet statutory requirements. However, the description itself is not intended to limit the scope of the patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various stems herein disclosed unless and except when the order of the individual steps is explicitly described.

Embodiments of the present invention provide computer-readable media, systems, and methods for integrating encapsulated advertisement controls. In various embodiments, one or more embedding instructions are received for embedding one or more encapsulated advertisement controls within an application, the one or more encapsulated advertisement controls including logic for handling of one or more advertisements and presentation of the advertisements to a user of the application, and one or more configuration instructions are received for configuring the one or more advertisement controls. Further, in various embodiments, one or more advertisements are presented to the user in accordance with the one or more presentation parameters. As used herein, the phrase “development environment” is intended to include various types of software development tools. For instance, in various embodiments the development environment may be directed to an integrated development environment. As used herein, the integrated development environment may include a source code editor, a compiler, and a debugger. Additionally, in various embodiments, the integrated development environment may include various data structures for use in object oriented development. In various embodiments the integrated development environment may be graphical. And, in various other embodiments, the integrated development environment may be text-based. Still further, as used herein, the phrase “development environment” may include other types of software development environments such as command-line development and software development kits (SDKs). Each of these contexts is contemplated and within the scope of “development environment” as used in connection with the present invention.

The term “application” is used herein to describe various software applications. The term is intended to be defined broadly and, thus, includes, but is not limited to, thick client applications, thin client applications, web-based applications, websites, and device applications. Each of these is contemplated and within the scope of “application” as used in connection with the present invention.

Accordingly, in one aspect, the present invention is directed to one or more computer-readable media having computer-usable instructions embodied thereon for performing a method for integrating advertisements using encapsulated advertisement controls. The method includes receiving one or more embedding instructions for embedding one or more encapsulated advertisement controls within an application, the one or more encapsulated advertisement controls including logic for handling of one or more advertisements and presentation of the advertisements to a user of the application, and receiving one or more configuration instructions from for configuring the one or more encapsulated advertisement controls. Further, the method includes presenting one or more advertisements to the user in accordance with the one or more advertisement presentation parameters.

In another aspect, the present invention is directed to one or more computer-readable media having computer-usable instructions embodied thereon for performing a method for integrating advertisements using encapsulated advertisement controls. The method includes receiving a request for one or more advertisement presentation parameters from an advertisement control coordinator associated with one or more encapsulated advertisement controls, the one or more encapsulated advertisement controls configured to be embedded within an application utilizing a development environment and the encapsulated advertisement control including logic for handling of one or more advertisements and presentation of the advertisements to a user of the application. The method further includes communicating the one or more advertisement presentation parameters to the advertisement control coordinator, receiving a request for one or more advertisements from the advertisement control coordinator, and communicating the one or more advertisements to the advertisement control coordinator.

In yet another aspect, the present invention is directed to a computerized system for integrating advertisements using encapsulated advertisement controls. The system includes one or more advertisement control components configured to be embedded within an application utilizing a development environment and further configured to handle one or more advertisements and to manage presentation of the advertisements to a user of the application. The system also includes a control coordinating component configured to manage one or more advertisement control components. Further, the system includes a database for storing information associated with the encapsulated advertisement controls.

Having briefly described an overview of embodiments of the present invention, an exemplary operating environment is described below.

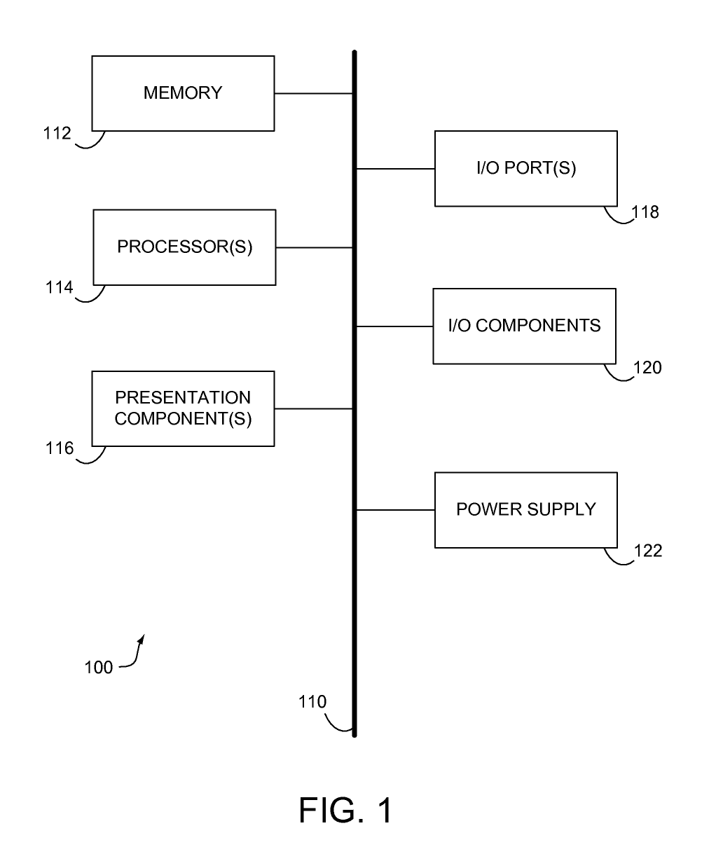

Referring to the drawing figures in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. The phrase “computer-usable instructions” may be used herein to include the computer code and machine-usable instructions. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

Computing device 100 includes a bus 110 that directly or indirectly couples the following elements: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid state memory, hard drives, optical disc drives, and the like. Computing device 100 includes one or more processors that read from various entities such as memory 112 or I/O components 120. Presentation component(s) 116 present data indications to a user or other device. Exemplary presentation components include a display device, speaker, printing component, vibrating component, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

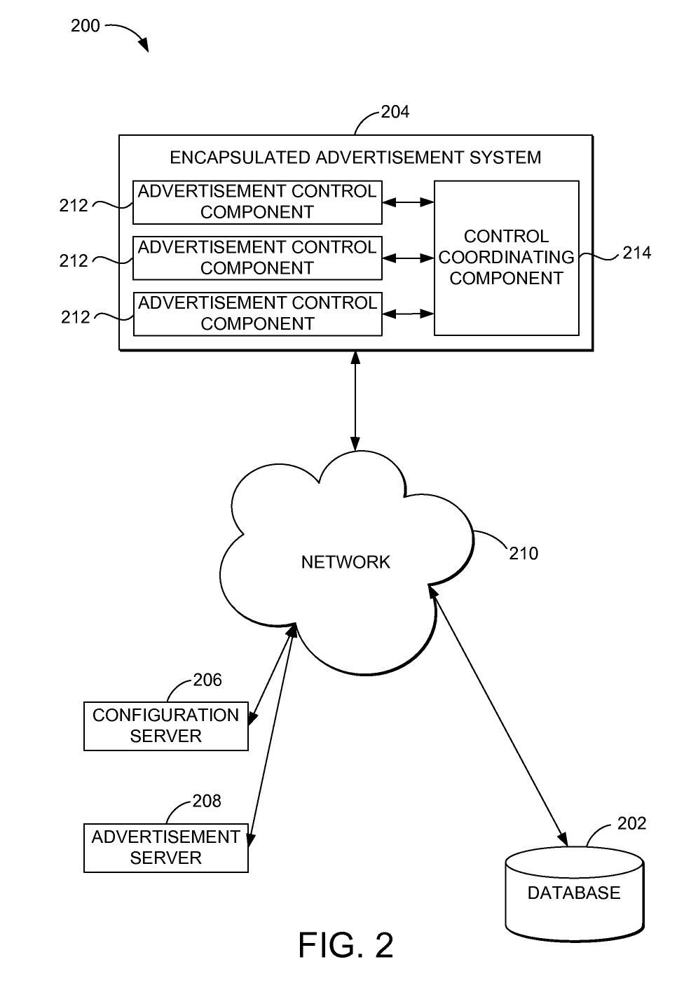

Turning now to FIG. 2, a block diagram is provided illustrating an exemplary system 200 for integrating encapsulated advertisement controls, in accordance with an embodiment of the present invention. The system 200 includes a database 202, an encapsulated advertisement system 204, a configuration server 206, and an advertisement server 208 in communication with one another via network 210. Network 210 may include, without limitation, one or more local area networks (LANs) and/or wide area networks (WANs). Such networking environments are commonplace in offices, enterprise-wide computer networks, intranets, and the Internet. Accordingly, network 210 is not further described herein.

Database 202 is configured to store information associated with encapsulated advertisement controls. In various embodiments, without limitation, such information may include video advertisements, audio advertisements, multimedia advertisements, appearance properties, business rules for advertisement rotation and event tracking, and various other types of configurable encapsulated advertisement control information. In various embodiments, database 202 is configured to be searchable so that encapsulated advertisement system 204, configuration server 206, and/or advertisement server 208 may retrieve encapsulated advertisement control information. Database 202 may be configurable and may include various information relevant to encapsulated advertisement controls. The content and/or volume of such information are not intended to limit the scope of embodiments of the present invention in any way. Further, although illustrated as a single, independent component, database 202 may, in fact, be a plurality of databases, for instance, a database cluster, portions of which may reside on a computing device associated with configuration server 206 and/or advertisement server 208, associated with encapsulated advertisement system 204, on another external computing device, or any combination thereof. Still further, although illustrated as independent from encapsulated advertisement system 204, in various embodiments, the entirety of database 202 may reside on a computing device associated with encapsulated advertisement system 204.

Encapsulated advertisement system 204 may be associated with a type of computing device, such as computing device 100 described with reference to FIG. 1, for example. For instance, in various embodiments, encapsulated advertisement system 204 may be associated with an application operating on computing device 100. As illustrated in FIG. 2, encapsulated advertisement system 204 is a single component located separately from the other components. This is intended for illustrative and discussion purposes only and is not meant to limit the system of the present invention to any particular configuration. For example, in various embodiments, encapsulated advertisement system 204 may reside on multiple computing devices. Each of these configurations, and others, are included within the scope of the present invention. As illustrated in FIG. 2, encapsulated advertisement system 204 includes one or more advertisement control components 212 and a control coordinating component 214. In various embodiments, encapsulated advertisement system 204 may be used by software developers to easily and efficiently include advertisements within an application. For instance, in various embodiments, developers can drag and drop encapsulated advertisement controls into an application using an integrated development environment and visually configure properties of the encapsulated advertisement control with minimal manual code writing. The encapsulated advertisement controls may include logic for presentation and handling of advertisements. Also, where the software developer includes more than one encapsulated advertisement control within an application coordinating logic that spans the multiple encapsulated advertisement controls (e.g., using control coordinating component 214 as discussed in more detail herein) may be available to coordinate the presentation of advertisements.

Before engaging in a discussion of the details of the various components included within encapsulated advertisement system 204, an exemplary overview discussion will be presented to help illustrate the overall functionality of system 204 in various embodiments. Accordingly, in embodiments, once the encapsulated advertisement controls have been embedded by a software developer into an application, various advertisement functionality is available to the application. While in the development environment, the software developer may also provide one or more configuration instructions to the encapsulated advertisement control defining the appearance of the encapsulated advertisement control within the application (size, shape, location, etc.). As previously stated, the encapsulated advertisement controls allow the software developer to include the sophisticated functionality associated with the advertisement controls without requiring extensive coding on the part of the software developer. The encapsulated advertisement controls provide the software developer with a new and useful tool because without encapsulated advertisement controls the developer must engage in extensive programming to provide a foundation for various advertisement functionality. Specifically, without encapsulated advertisement controls, a software developer must include advertisement-specific logic that enables an application to request an advertisement from an advertisement server, render the advertisement, monitor user interaction, and track presentation to determine advertisement rotation. Thus, the software developer is forced to expend extensive resources on development of the underlying advertisement functionality instead of focusing resources on the application development. Encapsulated advertisement controls integrated within a development environment relieve a software developer of this burden because the encapsulated advertisement controls already include the logic for presentation and handling of advertisements. Therefore, using encapsulated advertisement controls, a software developer may shift the resources presently expended on advertisement functionality, instead focusing those resources on application development.

The advertisement logic included within encapsulated advertisement controls is directed toward various advertisement functionality. For instance, in embodiments, the encapsulated advertisement control is capable of obtaining advertisement presentation parameters from a configuration server, such as configuration server 206, at run-time of the application. As discussed in more detail herein, the advertisement presentation parameters obtained may include, without limitation: advertisement request parameters configured to obtain one or more advertisement preferences from the user and to target advertisements to the user; advertisement rendering parameters configured to render presentation of one or more advertisements on a device, such as computing device 100 of FIG. 1; advertisement event reporting parameters configured to report a milestone and/or a user interaction to the advertisement server 208; and advertisement rotation parameters configured to rotate advertisements based upon a set of business rules obtained from advertisement server 208. In various embodiments, the advertisement presentation parameters are configurable on the configuration server. Thus, the software developer does not need to change the application code in order to alter advertisement presentation parameters for the presentation of advertisements. For example, even after shipment of an application product, the software developer is able to change advertisement configuration in the application by adjusting the advertisement presentation parameters on the configuration server. Further, in various embodiments, encapsulated advertisement controls may include logic for exposing the properties of the application to provide advertisement preference and targeting information. In various embodiments, an encapsulated advertisement control may use this information in constructing requests to the advertisement server, such as advertisement server 208.

The encapsulated advertisement controls may also, in various embodiments, include functionality for controlling the rendering of advertisements received from an advertisement server, such as advertisement server 208. For instance, the encapsulated advertisement control may manage presenting a static image, initializing multimedia players, overlaying an advertisement on a video stream, outputting an advertisement into an audio stream, and various other rendering that may be necessary for effective presentation of the advertisement. Also, in various embodiments, encapsulated advertisement controls may monitor, trap, and report events associated with the presentation of various advertisements. For instance, events may be milestones such as whether the advertisement was displayed, whether the advertisement was in the viewing area for a certain amount of time, and whether a video played for a certain amount of time. Also, events may be user interactions such as a click, a mouse-over, and rewinding a video stream. The events discussed herein are intended for exemplary purposes, but embodiments of the present invention contemplate monitoring, trapping, and reporting various events depending upon the requirements of the business rules associated with a particular advertisement. Still further, in various embodiments, encapsulated advertisement controls may be used to determine the appropriate rotation of advertisements. For instance, rotation may be based upon the time an advertisement is displayed and user interaction with the advertisement. In this example, when the rotation criteria associated with an advertisement is met, a new advertisement request will be initiated. Display time, visibility, and user interactivity may all be used individually, or in combination, to determine the appropriate rotation of an advertisement. For example, an advertisement may be rotated only if at least 90 percent of the advertisement is visible on the screen for a specified period of time. Further, by way of example, the advertisement may be configured to rotate only where the user has used the mouse or the keyboard at least twice in the last minute. Therefore, various events may be used to assist the advertiser in ensuring that an advertisement was visible on the screen and the user was interacting with the same screen for a period of time. Thus, in addition to reporting events back to an advertisement server, such as advertisement server 208, encapsulated advertisement controls also monitor various presentation time and user interaction for advertisement rotation. The advertisement rotation determination may be based on information associated with a single advertisement or, where there are multiple advertisements within an application, the rotation determination may consider each of the presented advertisements. Thus, as previously stated, encapsulated advertisement system 204 may include logic that spans more than one advertisement control, where necessary, to coordinate the presentation of multiple advertisements on multiple controls.

Having provided an overview discussion of encapsulated advertisement system 204 with a number of exemplary embodiments, the various components of encapsulated advertisement system 204 will now be discussed. One or more advertisement control components 212 are configured to manage presentation and handling of one or more advertisements and further configured for embedding within an application using a development environment. In various embodiments, the advertisement control components 212 manage the surface onto which the advertisement is rendered within an executing application. Thus, the advertisement control components are embedded within the application by a software developer using a development environment. The advertisement control components 212 may include logic for determining presentation and user interaction with the advertisement (e.g., how much of the advertisement is visible, whether there is a click, etc.), which is used both for event reporting back to advertisement server 208 as well as determining advertisement rotation.

Control coordinating component 214 is configured to manage one or more advertisement control components. Thus, in various embodiments where there is more than one advertisement control component 212, control coordinating component 214 includes the logic that spans the multiple advertisement control components 212. Further, in various embodiments, control coordinating component 214 interfaces with the configuration server 206 and the advertisement server 208 to request advertisement presentation parameters and advertisements. For example, where an application includes three advertisement control components for presenting three advertisements, the control coordinating component 214 may provide logic to coordinate the three advertisement control components 212 consistent with various business rules. For instance, assume the advertisements in this example are image advertisements that appear simultaneously in a column along the side of an application window for 30 seconds each. Advertisers may not want to have the same advertisement presented more than once at any given time. Control coordinating component 214 may, in various embodiments, include the logic to ensure that if an advertisement is displayed in association with one advertisement control component 212, it will not be simultaneously displayed with another advertisement control component 212. This example is intended for illustrative purposes only and embodiments of the present invention contemplate various other coordinating features that may be provided by control coordinating component 214. For instance, in embodiments, an advertiser may want a number of advertisements to appear sequentially from top to bottom in a column of advertisement control components 212.

Configuration server 206 is configured to provide one or more advertisement presentation parameters to at least one of the control coordinating component 214 and the advertisement control component 212. Thus, in various embodiments, configuration server 206 may be in communication with encapsulated advertisement system 204 directly through control coordinating component 214, which will convey advertisement presentation parameters to advertisement control components 212. In various other embodiments, however, configuration server 206 may be in contact with encapsulated advertisement system 204 directly through advertisement control components 212. In yet other embodiments, configuration server 206 may communicate with both control coordinating component 214 and advertisement control components 212. Each of these embodiments is contemplated and within the scope of the present invention. As illustrated, configuration server 206 is separate and distinct from advertisement server 208. This is intended for illustrative purposes only and is not meant to limit the scope of the present invention to any particular compartmentalized configuration. For instance, in various embodiments, configuration server 206 and advertisement server 208 may reside on or comprise a single computing device. Each of these configurations, and others, are included within the scope of the present invention. As illustrated in FIG. 2, configuration server 206 provides advertisement presentation parameters to an application through encapsulated advertisement system 204. As previously discussed, configuration server 206 may, in various embodiments, expose a user interface allowing software developers to adjust advertisement presentation parameters. Thus, where a software developer has embedded an encapsulated advertisement control within an application, the software developer may adjust the advertisement presentation parameters of the application even after the application has shipped because, in various embodiments, the application will obtain advertisement presentation parameters from configuration server 206 at run-time.

Advertisement server 208 is configured to provide one or more advertisements to at least one of the control coordinating component 214 and the advertisement control component 212. Thus, similar to configuration server 206, in various embodiments, advertisement server 208 may be in communication with encapsulated advertisement system 204 directly through control coordinating component 214, which will convey advertisement presentation parameters to advertisement control components 212. In various other embodiments, however, advertisement server 208 may be in contact with encapsulated advertisement system 204 directly through advertisement control components 212. In yet other embodiments, advertisement server 208 may communicate with both control coordinating component 214 and advertisement control components 212. As illustrated in FIG. 2, advertisement server 208 provides services for delivering advertisements. In various embodiments, the services may include advertisement selection, advertisement creative asset serving, and impression and event reporting. Therefore, in addition to providing advertisements, advertisement server 208 may receive event information from encapsulated advertisement system 204. For instance, advertisement server 208 may compile information on the effectiveness of a particular advertisement by tracking the click-through rate of the advertisement when it is displayed on various advertisement control components 212.

As discussed herein, advertisement server 208 is part of an online advertisement system that is in communication with the encapsulated advertisement system 204 which may be configured to reference the network directly. In various embodiments, however, advertisement server 208 may be part of a semi-connected advertisement system that periodically syncs with encapsulated advertisement system 204. For instance, encapsulated advertisement system 204 may reference advertisement information that was cached on a local store using a semi-connected advertisement system.

It will be understood and appreciated by those of ordinary skill in the art that additional components not shown may also be included within any of system 200, database 202, encapsulated advertisement system 204, configuration server 206, and advertisement server 208.

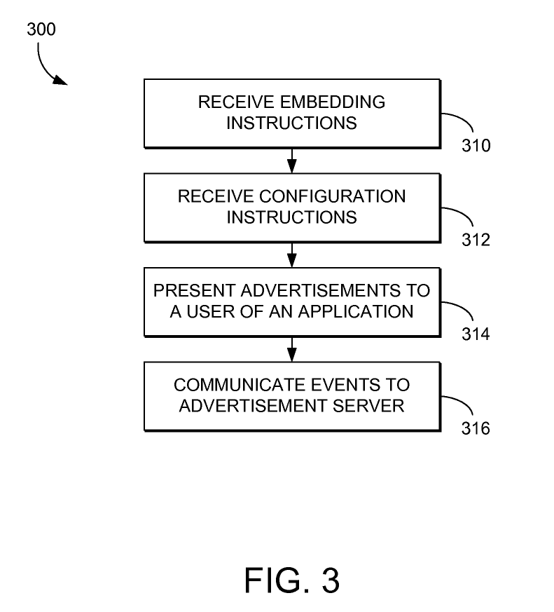

Turning now to FIG. 3, a flow diagram of an exemplary method for integrating encapsulated advertisement controls, in accordance with an embodiment of the present invention, is illustrated and designated generally as reference numeral 300. Initially, as indicated at block 310, embedding instructions are received for embedding one or more encapsulated advertisement controls within an application, e.g., by advertisement control component 212 of encapsulated advertisement system 204 of FIG. 2. For instance, a software developer working in a development environment may provide the embedding instructions to embed an encapsulated advertisement control, such as advertisement control component 212, into a software application. As previously discussed with reference to FIG. 2, the encapsulated advertisement control may include logic for presentation and handling of one or more advertisements. In various embodiments, the development environment is an integrated development environment and the software developer can visually drag and drop the encapsulated advertisement control into the application.

Next, as indicated at block 312, configuration instructions are received for configuring the encapsulated advertisement controls, e.g., by advertisement control component 212 of encapsulated advertisement system 204 of FIG. 2. For instance, a software developer may provide configuration instructions to configure the one or more encapsulated advertisement controls included within an application. In various embodiments, configuration instructions may be directed to the size, shape, and location of the encapsulated advertisement control within the application. For instance, a software developer may want a single tall and narrow advertisement to appear on the right side of an application when the application is running. In that example, the software developer would submit configuration instructions to configure the encapsulated advertisement control. In various embodiments, upon dragging and dropping an encapsulated advertisement control into an application, an encapsulated advertisement control may expose configurable properties to the software developer so the developer can provide configuration instructions with minimal manual code writing.

Next, as indicated at block 314, one or more advertisements are presented to a user of the application in accordance with one or more advertisement presentation parameters. In various embodiments, the advertisements may be obtained from an advertisement server, such as advertisement server 208 of FIG. 2, during run-time of the application. Also, in various embodiments, the advertisement presentation parameters may be obtained from a configuration server, such as configuration server 206 of FIG. 2, during run-time of the application. Thus, by way of example, when a user of an application having encapsulated advertisement controls embedded within it initiates the application, an advertisement will be presented to a user through a device, e.g. computing device 100 of FIG. 1, while the application is active on the device. As previously discussed, the encapsulated advertisement control includes logic for presentation and handling of the advertisement and, thus, various rendering and advertisement rotation schemes will be included depending upon various business rules and the advertisement presentation parameters.

Optionally, in various embodiments, as indicated at block 316, events are communicated to the advertisement server, e.g., advertisement server 208 of FIG. 2 by, e.g., control coordinating component 214 of encapsulated advertisement system 204 of FIG. 2. For example, as previously stated, events may include a milestone (e.g., time displayed, whether the advertisement was visible, whether a video played, etc.) and/or a user interaction (e.g., mouse click, mouse-over, rewind of a video stream, etc.). In various embodiments events may be reported to the advertisement server in real time such that when an event takes place it will be reported. In various other embodiments, however, the encapsulated advertisement control, e.g., through encapsulated advertisement system 204 of FIG. 2, may log the events for reporting at a later time.

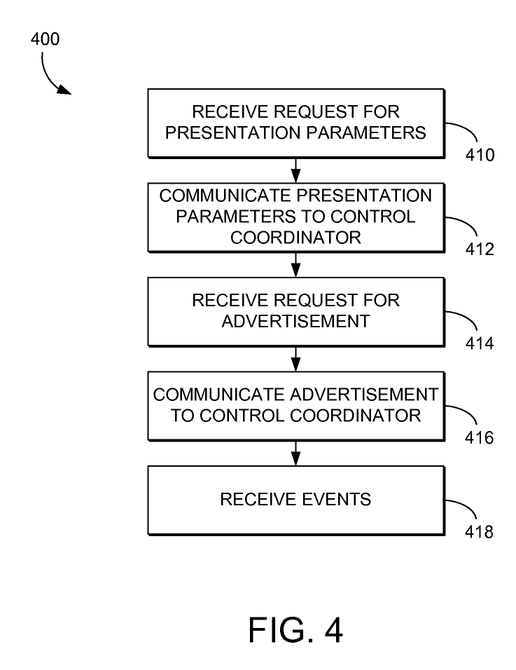

Turning now to FIG. 4, a flow diagram of an exemplary method for integrating encapsulated advertisement controls, in accordance with an embodiment of the present invention, the flow having a different perspective than the flow illustrated in FIG. 3, is illustrated and designated generally as reference numeral 400. Initially, as indicated at block 410 a request is received for one or more advertisement presentation parameters from an advertisement control coordinator associated with one or more encapsulated advertisement controls. As previously stated, the one or more encapsulated advertisement controls may be configured for embedding within an application utilizing a development environment. Further, the encapsulated advertisement controls may include logic for presentation and handling of one or more advertisements. For example, the request for advertisement presentation parameters may be received by configuration server 206 of FIG. 2. As previously discussed, the advertisement presentation parameters may include a variety of parameters including, but not limited to, advertisement request parameters, advertisement rendering parameters, advertisement event reporting parameters, and advertisement rotation parameters. Also, as previously discussed, the advertisement presentation parameters may be configurable on a configuration server, such as configuration server 206 of FIG. 2. Thus, even after an application including encapsulated advertisement controls has been shipped, a software developer may alter the presentation of advertisements within the application. Next, as indicated at block 412, one or more advertisement presentation parameters are communicated to the advertisement control coordinator, e.g., control coordinating component 214 of encapsulated advertisement system 204 of FIG. 2.

Then, as indicated at block 414, a request is received for one or more advertisements, e.g., by advertisement server 208 of FIG. 2. As previously discussed with reference to FIGS. 2 and 3, an encapsulated advertisement control may, periodically, request advertisements to present from the advertisement server. The advertisement server, as indicated at block 416, will communicate the one or more advertisements to the advertisement control coordinator, e.g., control coordinating component 214 of encapsulated advertisement system 204 of FIG. 2.

Optionally, in various embodiments, as indicated at block 418, events are received from the advertisement control coordinator, e.g., control coordinating component 214 of encapsulated advertisement system 204 of FIG. 2, by e.g., advertisement server 208 of FIG. 2. As previously discussed with reference to FIGS. 2 and 3, events may include a milestone (e.g., time displayed, whether the advertisement was visible, whether a video played, etc.) and/or a user interaction (e.g., mouse click, mouse-over, rewind of a video stream, etc.). In various embodiments events may be received in real time such that when an event takes place it will be reported. In various other embodiments, however, the encapsulated advertisement control, e.g., through encapsulated advertisement system 204 of FIG. 2, may log the events and the events may be received after a specified period of time or upon occurrence of an event, such as the termination of the application.

In of the exemplary methods described herein, various combinations and permutations of the described blocks or steps may be present and additional steps may be added. Further, one or more of the described blocks or steps may be absent from various embodiments. It is contemplated and within the scope of the present invention that the combinations and permutations of the described exemplary methods, as well as any additional or absent steps, may occur. The various methods are herein described for exemplary purposes only and are in no way intended to limit the scope of the present invention.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the methods, computer-readable media, and systems. It will be understood that certain features and sub-combinations are of utility and may be employed without reference to other features and sub-combinations. This is contemplated by and within the scope of the claims.

The invention claimed is:

1. One or more computer-readable media having computer-usable instructions embodied thereon for performing a method for integrating advertisements using encapsulated advertisement controls, the method comprising:
receiving one or more embedding instructions for embedding one or more encapsulated advertisement controls within an application, the one or more encapsulated advertisement controls including logic for handling of one or more advertisements and presentation of the advertisements to a user of the application.
receiving one or more configuration instructions for configuring the one or more encapsulated advertisement controls; and
presenting the one or more advertisements to the user in accordance with one or more advertisement presentation parameters.

2. The computer-readable media of claim 1, wherein the one or more advertisement presentation parameters are obtained from a configuration server during run-time of the application.

3. The computer-readable media of claim 2, wherein the one or more advertisements are obtained from an advertisement server during run-time of the application.

4. The computer-readable media of claim 3, further comprising:
communicating events to the advertisement server.

5. The computer-readable media of claim 4, wherein the embedding instructions and the configuration instructions are received from within a development environment.

6. The computer-readable media of claim 5, wherein the application is one or more of a thick client application, a thin client application, a web-based application, a website, and a device.

7. The computer-readable media of claim 6, wherein the one or more advertisement presentation parameters include one or more advertisement request parameters configured to obtain one or more advertisement preferences from the user and to target the one or more advertisements to the user in accordance with the one or more advertisement preferences.

8. The computer-readable media of claim 6, wherein the one or more advertisement presentation parameters include one or more advertisement rendering parameters configured to render presentation of the one or more advertisements on a device.

9. The computer-readable media of claim 6, wherein the one or more advertisement presentation parameters include one or more advertisement event reporting parameters configured to report at least one of a milestone and a user interaction to the advertisement server.

10. The computer-readable media of claim 6, wherein the one or more advertisement presentation parameters include one or more advertisement rotation parameters configured to rotate the one or more advertisements based upon a set of business rules obtained from the advertisement server.

11. One or more computer-readable media having computer-usable instructions embodied thereon for performing a method for integrating advertisements using encapsulated advertisement controls, the method comprising:
receiving a request for one or more advertisement presentation parameters from an advertisement control coordinator associated with one or more encapsulated advertisement controls, the one or more encapsulated advertisement controls configured to be embedded within an application utilizing a development environment and the one or more encapsulated advertisement controls including logic for handling of one or more advertisements and presentation of the advertisements to a user of the application;
communicating the one or more advertisement presentation parameters to the advertisement control coordinator;
receiving a request for the one or more advertisements from the advertisement control coordinator; and
communicating the one or more advertisements to the advertisement control coordinator.

12. The computer-readable media of claim 11, wherein the one or more advertisement presentation parameters and the one or more advertisements are requested during run-time of the application.

13. The computer-readable media of claim 12, further comprising:
receiving events from the advertisement control coordinator.

14. The computer-readable media of claim 13, wherein the application is one or more of a thick client application, a thin client application, a web-based application, a website, and a device.

15. A computerized system for integrating advertisements using encapsulated advertisement controls, the system comprising:
one or more advertisement control components configured to be embedded within an application utilizing a development environment and further configured to handle one or more advertisements and to manage presentation of the advertisements to a user of the application;
a control coordinating component configured to manage the one or more advertisement control components; and
a database for storing information associated with the encapsulated advertisement controls.

16. The computerized system of claim 15, wherein the control coordinating component is further configured to communicate with a configuration server to obtain one or more advertisement presentation parameters.

17. The computerized system of claim 16, wherein the control coordinating component is further configured to communicate with an advertisement server to obtain one or more advertisements.

18. The computerized system of claim 17, wherein the application is one or more of a thick client application, a thin client application, a web-based application, a website, and a device.

19. The computerized system of claim 18, wherein the one or more advertisement presentation parameters include at least one of an advertisement request parameter configured to obtain one or more advertisement preferences from the user and to target the one or more advertisements to the user in accordance with the one or more advertisement preferences and an advertisement rendering parameter configured to render presentation of the one or more advertisements on a device.

20. The computerized system of claim 18, wherein the one or more advertisement presentation parameters include at least one of an advertisement event reporting parameter configured to report at least one of a milestone and a user interaction to the advertisement server and an advertisement rotation parameter configured to rotate the one or more advertisements based upon a set of business rules obtained from the advertisement server.
